(19) United States
(12) Patent Application Publication
(10) Pub. No.: US 2025/0354793 A1
(43) Pub. Date: Nov. 20, 2025

(54) Battery Pack Deformation Detection Device and Battery Assembly

(71) Applicant: Robert Bosch GmbH, Stuttgart (DE)

(72) Inventor: Zeyu Wang, Suzhou (CN)

(21) Appl. No.: 19/207,706

(22) Filed: May 14, 2025

(30) Foreign Application Priority Data
May 17, 2024 (CN) 2024 2108 7621.3

(51) Int. Cl. G01B 7/16; H01M 10/48

(52) U.S. Cl. CPC G01B 7/18; H01M 10/48

(57) ABSTRACT

A battery pack deformation detection device and a battery assembly includes (i) at least one conductor fiber and fixed film, the fixed film being configured as a deformable insulating film, and (ii) the conductor fiber is fixedly applied to the fixed film so that when the fixed film is deformed, the conductor fiber is also deformed.

This application claims priority under 35 U.S.C. § 119 to application no. CN 2024 2108 7621.3, filed on May 17, 2024 in China, the disclosure of which is incorporated herein by reference in its entirety.

The present application relates to the technical field of battery pack fault detection, and in particular, to a battery pack deformation detection device and a battery assembly.

### BACKGROUND

As the main source of power for new energy vehicles, the safety of batteries during daily use is particularly important for the passive safety of the entire vehicle. Known battery fault detection systems are usually able to detect battery pack failures and notify users only when or after a battery pack failure occurs, such as when the battery pack leaks, has thermal runaway, catches fire, or has other problems. However, when the battery pack is deformed and has a high risk of causing the above obvious faults, it is difficult to pre-detect this and provide warnings to users to remind them to check or replace the battery pack.

It should be noted that the information disclosed in the above background technology section is only used to enhance the understanding of the background of the present disclosure and therefore may include information that does not constitute prior art known to ordinary technicians in the field.

### SUMMARY

According to different aspects, one of the purposes of the present application is to detect battery pack deformation to provide early warning of battery pack failure.

Further, the present application is also intended to address or mitigate other technical issues present in the prior art.

According to one aspect of the present application, the following is provided:
a battery pack deformation detection device comprising at least one conductor fiber and fixed film, wherein the fixed film is configured as a deformable insulating film and the conductor fiber is fixedly applied to the fixed film so that when the fixed film is deformed, the conductor fiber is also deformed.

According to another aspect of the present application, the present application provides a battery assembly, wherein the battery assembly has a battery pack and the battery pack deformation detection device described above and the battery pack deformation detection device is fixedly applied to the surface of the battery pack through the fixed film.

Benefits of the present application include:

The battery pack deformation detection device of the present application utilizes a combination of conductor fibers and fixed film applied to the battery pack to determine whether the battery pack is deformed. When the battery pack is deformed, it can simply detect whether the battery pack is in a deformed state based on changes in the resistance value of the conductor fibers, thereby reducing the risk of battery failure or thermal accidents due to battery pack deformation.

### BRIEF DESCRIPTION OF THE DRAWINGS

The above and other features of the present application will become apparent with reference to the accompanying drawings, wherein,

FIG. 1 illustrates a structural schematic diagram of a battery pack deformation detection device according to one embodiment of one aspect of the present application;

FIG. 2 illustrates a structural schematic diagram of a battery pack deformation detection device according to another embodiment of one aspect of the present application;

FIG. 3 illustrates a structural schematic diagram of a battery assembly according to one embodiment of another aspect of the present application.

### DETAILED DESCRIPTION

It will be readily understood that according to the technical solution of the present application, without changing the spirit of the present application, one of ordinary skill in the art may propose a variety of interchangeable structural methods and implementation methods. Therefore, the following specific embodiments and attached drawings are only exemplary descriptions of the technical solutions of the present application, and shall not be considered as all of the present application or as a limitation or restriction of the technical solutions of the present application.

The terms up, down, left, right, front, back, front, rear, top, bottom, and the like mentioned or possibly mentioned in the Specification are defined relative to the constructions shown in the accompanying drawings and are relative concepts, and therefore may vary accordingly depending on their different locations and different states of use. Therefore, these or other orientation terms should not be construed as limiting. Further, the terms “first,” “second,” “third,” and the like or similar expressions are used solely for the purpose of description and differentiation and are not to be understood as indicating or implying the relative importance of the respective components or the order of precedence or assembly of the components.

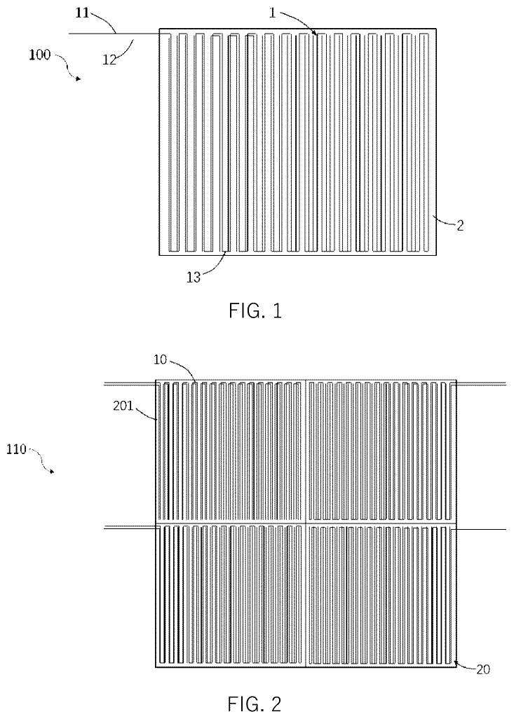

Referring to FIG. 1, it illustrates a structural schematic diagram of a battery pack deformation detection device 100 according to one embodiment of one aspect of the present application. The battery pack deformation detection device 100 is used to detect the deformation of the battery pack 200, including but not limited to deformation conditions such as bulging, skewing, breakage, scratches, etc. of the battery pack 200. In this embodiment, the battery pack deformation detection device 100 includes at least one conductor fiber 1 (only one conductor fiber is schematically shown in FIG. 1) and a fixed film 2. The fixed film 2 is configured as an insulating film, which can be deformed to a certain extent and can be torn when the tension is great. The conductor fiber 1 is fixedly applied to the fixed film 2, and in particular, is bonded to the fixed film 2 in its extension direction, so that the conductor fiber 1 is also deformed when the fixed film 2 is deformed. The battery pack deformation detection device 100 is bonded to the surface of the battery pack 200 by the fixed film 2. In this way, when the surface of the battery pack 200 is deformed, such as bulging, the fixed film 2 attached to the surface of the battery pack 200 will deform along with the battery pack 200 or be torn when the deformation of the battery pack is great. At the same time, the conductor fiber 1 fixed to the fixed film 2 will also deform along with the fixed film 2 (typically, the conductor fiber 1 is stretched when the fixed film 2 is deformed) or be broken (for example, when the fixed film 2 is torn). At this time, the resistance of the conductor fiber 1 will change due to its deformation. By detecting the change in the resistance of the conductor fiber 1, it can be determined whether the battery pack 200 has been deformed.

It should be understood that the “deformation” in the “battery pack deformation detection mechanism” mentioned in the present application should not be understood only as the geometric change of the overall shape of the battery pack, but should also include situations such as battery pack damage, scratches, etc. that affect the surface shape of the battery pack.

In one embodiment of the present application, the fixed film 2 has two layers and the conductor fiber 1 is sandwiched between the two layers of the fixed film 2 and bonded to both layers of the fixed film 2. The conductor fiber 1 can be better fixed by two layers of the fixed film 2 such that it does not easily move relative to the fixed film 2, thereby ensuring that when the fixed film 2 is deformed or broken, the conductor fiber 1 is also deformed or broken by the fixed film 2.

In one implementation of the present application, the conductor fiber 1 has an input 11, an output 12, and a bend 13 coupled between the input 11 and the output 12. The bend 13 is arranged between the two layers of the fixed film 2 and the input 11 and the output 12 are respectively located at the two ends of the bend 13 and extend from the fixed film 2 by the bend 13 at the same position of the fixed film 2. This arrangement is conducive to easily connecting the input 11 and the output 12 of the conductor fiber 1 to the resistance measuring circuit without adding additional connecting conductors. The bend 13 is configured to increase the area of contact of the conductor fiber 1 with the fixed film 2 and further to increase the area of coverage of the conductor fiber 1 on the surface of the battery pack 200. Therefore, the bend 13 of the conductor fiber 1 covers as much area of the fixed film 2 as possible so as to be able to detect the deformation of the fixed film 2 covering the surface of the battery pack 200 as much as possible. In the embodiment of FIG. 1, the fixed film 2 is configured in a rectangular shape and the bend 13 is configured in a rectangular pulse shape so that the bend 13 covers as much of the area of the fixed film 2 as possible. Of course, it should be understood that the fixed film 2 may also be configured in other shapes, such as circular or other irregular shapes, and the bend 13 may be configured in other shapes accordingly to better cover the area of the fixed film 2. For example, in a circular fixed film, the bend can be configured in a spiral labyrinthine shape that is wound spirally.

In one embodiment of the present application, the conductor fiber 1 is made of carbon fiber or copper fiber, which can conduct electricity and has a certain resistance. When the conductor fiber 1 is stretched (that is, when the cross-sectional area is reduced), its resistance value increases. An insulating layer is provided on the surface of the conductor fiber 1 to prevent short circuits between adjacent conductor fibers 1.

In one embodiment of the present application, the fixed film 2 is made of TPU (thermoplastic polyurethane).

Referring to FIG. 2, it shows a structural schematic diagram of an battery pack deformation detection device according to another embodiment of one aspect of the present application. In the embodiment of FIG. 2, the battery pack deformation detection device 110 includes a plurality of conductor fibers 10 (4 schematically in FIG. 2), with respective detection areas 201 matching these conductor fibers 10 provided on the fixed film 20. The bend of each conductor fiber 10 is arranged in a corresponding detection area 201. In this way, the fixed film 20 may be divided into a plurality of areas 201 and one conductor fiber 10 can be used to detect each area 201. These detection areas 201 of the fixed film 20 also correspond to different areas of the surface of the battery pack 200 when arranged on the battery pack 200. Thus, by detecting the increase or disconnection of the resistance of one or several conductor fibers 10, it can be accurately determined that the detection area 201 corresponding to the one or several conductor fibers 10 on the fixed film 20 has been deformed or torn, and it can also be inferred that the corresponding area on the surface of the battery pack 200 has been deformed. By arranging a plurality of conductor fibers 10 and dividing a plurality of detection areas 201 on the fixed film 20, the battery pack deformation detection device 110 is able to further achieve the detection of deformation at different areas of the battery pack 200, thus narrowing the detection accuracy range.

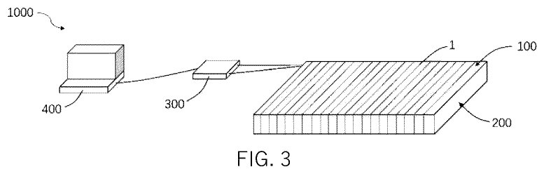

Another aspect of the present application further provides a battery assembly 1000. Referring to FIG. 3, it illustrates a structural schematic diagram of a battery assembly 1000 according to one embodiment of another aspect of the present application. The battery assembly 1000 includes the battery pack deformation detection devices 100 and 110 and the battery pack 200, and the battery pack deformation detection devices 100 and 110 are fixedly applied, in particular bonded, by the fixed films 2 and 20 to the surface of the battery pack 200. As a result, when the battery pack 200 undergoes deformation, the deformation of its surface drives the deformation of the fixed films 2 and 20, thereby driving the deformation of the conductor fibers 1 and 10, in particular stretching or breaking them.

In one embodiment of another aspect of the present application, the battery assembly 1000 further comprises a resistance measuring mechanism 300 coupled to the conductor fibers 1 and 10 to measure the resistance of the conductor fibers 1 and 10. The resistance measuring mechanism 300 is particularly connected to the input 11 and output 12 of the conductor fiber 1 to detect the resistance of the conductor fiber 1. When there is a plurality of conductor fibers 10, if this is only for the purpose of detecting whether the battery pack 200 as a whole is deformed, the plurality of conductor fibers 10 can be connected in parallel to the resistance measuring mechanism 300 to detect whether the total resistance in parallel has changed. If it is necessary to detect the deformation area of the battery pack 200, each of the plurality of conductor fibers 10 can be connected to the resistance measuring mechanism 300 in turn to detect whether the resistance of each conductor fiber 300 has changed.

In one embodiment of another aspect of the present application, the battery assembly 1000 further comprises a control unit 400 in communication with the resistance measuring mechanism 300. The control unit 400 judges whether the battery pack 200 is deformed based on the measurement results of the resistance values of the conductor fibers 1 and 10 by the resistance measuring mechanisms 100 and 110. The initial resistance value of the conductor fibers 1 and 10 in a normal state is preset in the control unit 400 and the initial resistance value is compared to the resistance of the conductor fibers 1 and 10 currently measured by the resistance measuring mechanisms 100 and 110. If the currently measured resistance of the conductor fibers 1 and 10 is greater than the initial resistance or the conductor fibers 1 and 10 are open-circuited (the resistance is positive infinite), the control unit 400 judges that the battery pack is deformed and notifies the user to check or replace the battery pack 200. Of course, the degree of deformation of the conductor fibers 1 and 10 can also be inferred from the change in the resistance values of the conductor fibers 1 and 10, allowing the degree of deformation of the battery pack 200 to be inferred to some extent. The control unit 400 is capable of being integrated into, for example, the electronic control unit of the vehicle.

It should be understood that the above battery pack deformation detection mechanisms 100 and 110 can also be used for deformation detection of other vehicle parts, such as deformation detection of vehicle doors, trunk lids, and other parts. At this time, the battery pack deformation detection mechanisms 100 and 110 can also be applied to these parts by, for example, fixed films 2 and 20, and the deformation of these parts is detected according to the same principle.

It should be understood that all of the above preferred examples are exemplary and non-limiting, and various modifications or variations made by those skilled in the art to the specific examples described above under the concept of the present application shall be within the scope of legal protection of the present application.

What is claimed is:

1. A battery pack deformation detection device, comprising:
at least one conductor fiber; and
a fixed film which is configured as a deformable insulating film,
wherein the at least one conductor fiber is fixedly applied to the fixed film so that when the fixed film is deformed, the at least one conductor fiber is also deformed.

2. The battery pack deformation detection device according to claim 1, wherein:
the fixed film has two layers, and
the at least one conductor fiber is bonded between the two layers of the fixed film.

3. The battery pack deformation detection device according to claim 2, wherein:
the at least one conductor fiber has an input portion, an output portion, and a bend portion between the input portion and the output portion,
the bend portion is arranged between two layers of the fixed film, and
the input portion and the output portion extend from the fixed film by the bend portion from the same position of the fixed film.

4. The battery pack deformation detection device according to claim 3, wherein the bend portion is configured in a shape of a rectangular pulse.

5. The battery pack deformation detection device according to claim 1, wherein the at least one conductor fiber is made of carbon fiber or copper fiber.

6. The battery pack deformation detection device according to claim 1, wherein the fixed film is made of TPU.

7. The battery pack deformation detection device according to claim 3, wherein:
the at least one conductive fiber comprises a plurality of conductor fibers,
detection areas respectively matching each conductor fiber of the plurality of conductor fibers are provided on the fixed film, and
the bend portion of each of the plurality of conductor fibers is arranged in a corresponding detection area.

8. A battery assembly, comprising:
a battery pack; and
a battery pack deformation detection device according to claim 1,
wherein the battery pack deformation detection device is fixedly applied to a surface of the battery pack through the fixed film.

9. The battery assembly according to claim 8, further comprising a resistance measuring mechanism connected to the at least one conductor fiber and configured to measure the resistance of the at least one conductor fiber.

10. The battery assembly according to claim 9, further comprising a control unit in communication with the resistance measuring mechanism and configured to determine the deformation of the battery pack when the resistance measuring mechanism measures that the resistance of the at least one conductor fiber has increased or the at least one conductor fiber is disconnected.
